(19) United States
(12) Patent Application Publication
(10) Pub. No.: US 2008/0168784 A1
(43) Pub. Date: Jul. 17, 2008

(54) Air conditioning system and method of controlling the same

(75) Inventors: Ji Hoon Choi, Hwaseong-si (KR); Phil Soo Chang, Seongnam-si (KR); Kyung Rae Cho, Suwon-si (KR); In Ju Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/907,393

(22) Filed: Oct. 11, 2007

(30) Foreign Application Priority Data
Jan. 15, 2007 (KR) 10-2007-4310

(51) Int. Cl. F25B 1/10; G05D 99/00

(52) U.S. Cl. 62/157; 62/510

(57) ABSTRACT

An air conditioning system including a first compressor and a second compressor provided in parallel with the first compressor to vary compression capacity. The second compressor includes a housing having a compressing chamber, a vane that moves forward and backward in a radial direction of the compressing chamber, a vane guide groove formed in the housing to guide the forward and backward movements of the vane, and a vane controller that controls the operation of the vane in order to vary capacity. The vane controller includes a control valve that switches a fluid path so as to selectively apply suctioning pressure of the second compressor and discharge pressure of the first compressor to the vane guide groove and a controller that controls a fluid path switching operation of the control valve by a pulse width modulation (PWM) method in accordance with air conditioning load.

### CROSS-REFERENCE TO RELATED APPLICATIONS

This application claims the benefit of Korean Patent Application No. 2007-4310, filed on Jan. 15, 2007, in the Korean Intellectual Property Office, the disclosure of which is incorporated herein by reference.

### BACKGROUND

1. Field

The present invention relates generally to an air conditioning system and a method of controlling the same, and more particularly to an air conditioning system capable of varying compression capacity in multiple steps and rapidly varying the compression capacity and a method of controlling the same.

2. Description of the Related Art

Recently, an air conditioning system controls compression capacity of a compressor in accordance with cooling load to control cooling efficiency. In Korean Unexamined Patent Application Publication No. 2002-75603, a method of adopting two compressors having different capacities to selectively drive the two compressors is disclosed as a method of controlling the compression capacity. In the method, one of the two compressors is selected to be operated or both of the two compressors are operated as occasion demands to control the compression capacity in three steps.

However, since the variation of the compression capacity is limited to three steps in such an air conditioning system, there are limitations on improving the performance and energy efficiency of the system. That is, since it is not possible to correctly vary the compression capacity, there are limitations on improving the performance and efficiency of the system. In such a system, an inverter is adopted to a motor that drives the compressors to control the rotation speed of the motor and to thus vary the compression capacity in multiple steps. However, in such a case, the manufacturing costs for a controller are excessively increased.

Also, in Korean Patent No. 10-621026 (published on Sep. 15, 2006), a variable capacity rotary compressor for an air conditioning system capable of varying compression capacity is disclosed. The compressor includes a first vane defining an upper compressing chamber and a second vane defining a lower compressing chamber and has a vane controller that selectively locks or releases the second vane to vary the compression capacity. The vane controller includes a common connecting pipe connected to the back pressure space of the second vane, a high pressure connecting pipe connected to the common connecting pipe, a low pressure connecting pipe connected to the common connecting pipe, a three way valve type back pressure switching valve provided at the point where the connecting pipes are connected to each other. The vane controller allows suctioning pressure to be applied to the back pressure space of the second vane so that the second vane is locked or allows discharge pressure to be applied to the back pressure space of the second vane so that the second vane moves forward or backward by the operation of the back pressure switching valve.

However, according to the variable capacity rotary compressor, since the pressure applied to the back pressure space of the second vane during an initial operation is not sufficient, a normal compressing operation is not performed in the second compressing chamber such that the second vane chatters. That is, a normal capacity variable operation is not performed until sufficient pressure is applied to the back pressure space.

### SUMMARY

Accordingly, the present invention has been made to solve above-mentioned problems occurring in the prior art, and an aspect of the present invention is to provide an air conditioning system capable of varying compression capacity in multiple steps in accordance with air conditioning load and a method of controlling the same.

Additional aspects and/or advantages will be set forth in part in the description which follows and, in part, will be apparent from the description, or may be learned by practice of the invention.

Another aspect of the present invention is to provide an air conditioning system capable of rapidly varying compression capacity and a method of controlling the same.

In order to accomplish these aspect, an air conditioning system includes a first compressor and a second compressor provided in parallel with the first compressor to vary compression capacity. The second compressor includes a housing having a compressing chamber, a vane that moves forward or backward in a radial direction of the compressing chamber, a vane guide groove formed in the housing to guide the vane moving in a forward direction or a backward direction, and a vane controller that controls the operation of the vane in order to vary capacity. The vane controller includes a control valve that switches fluid paths so as to selectively apply suctioning pressure of the first or second compressor and discharge pressure of the first compressor to the vane guide groove.

The vane controller may include a connecting pipe that connects the vane guide groove and the control valve to each other, a high pressure pipe that connects the control valve and a discharging side of the first compressor to each other, and a low pressure pipe that connects the control valve and a suctioning side of the first or second compressor to each other.

The air conditioning system may further include a controller that controls an operation of the control valve by a pulse width modulation (PWM) method in order to vary compression capacity of the second compressor in accordance with air conditioning load.

The air conditioning system may further include an outdoor heat exchanger connected to discharging sides of the first and second compressors, indoor heat exchangers whose inlets are connected to the outdoor heat exchanger and whose outlets are connected to suctioning sides of the first and second compressors, and electronic expansion valves provided on receiving sides of the indoor heat exchangers.

The plurality of indoor heat exchangers may be provided in parallel. The electronic expansion valves may be provided on the receiving sides of the plurality of indoor heat exchangers.

Further, there is provided an air conditioning system, which includes a first compressor and a second compressor provided in parallel with the first compressor to vary compression capacity. The second compressor includes a housing having first and second compressing chambers which are separated from each other, first and second vanes that moves forward or backward in a radial direction of the compressing chambers, first and second vane guide grooves formed in the housing to guide the forward and backward movement of the first and second vanes, and a vane controller that controls the operation of the first vane in order to vary capacity. The vane controller includes a control valve that switches a fluid path so as to selectively apply suctioning pressure of the first or second compressor and discharge pressure of the first compressor to the first vane guide groove.

The vane controller may include a connecting pipe that connects the first vane guide groove and the control valve to each other, a high pressure pipe that connects the control valve and a discharging side of the first compressor to each other, and a low pressure pipe that connects the control valve and a suctioning side of the first or second compressor to each other.

In addition, there is provided a method of controlling an air conditioning system including a first compressor and a second compressor provided in parallel with the first compressor to vary compression capacity by controlling forward and backward movements of a vane and a control valve that switches a fluid path so as to selectively apply suctioning pressure of the second compressor and discharge pressure of the first compressor to a rear space of the vane in order to control the forward and backward movements of the vane. After the first compressor is driven, the second compressor is driven after a setting time has lapsed.

Desired compression capacity in accordance with air conditioning load is calculated before driving the first compressor. A fluid path switching operation of the control valve is controlled by a PWM method in order to realize compression capacity suitable for the desired compression capacity after driving the second compressor.

A compressing operation of the second compressor is performed after a discharge pressure of the first compressor is applied to a rear space of the vane.

In addition, there is provided a method of controlling an air conditioning system including a first compressor and a second compressor provided in parallel with the first compressor to vary compression capacity by controlling forward and backward movements of a vane and a control valve that switches a fluid path so as to selectively apply suctioning pressure of the second compressor and discharge pressure of the first compressor to a rear space of the vane in order to control the forward and backward movements of the vane. Desired compression capacity in accordance with air conditioning load is calculated. A fluid path switching operation of the control valve is controlled by a PWM method in order to realize compression capacity suitable for the desired compression capacity after driving the first and second compressors.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of an air conditioning system according to a first embodiment of the present invention;

FIG. 2 is a sectional view illustrating the second compressor and the vane controller of the air conditioning apparatus according to the first embodiment of the present invention;

FIG. 3 is a sectional view taken along the line III-III′ of FIG. 2;

FIG. 4 is a block diagram of the air conditioning system according to the first embodiment of the present invention, which illustrates the idling state of the second compressor;

FIG. 5 is a block diagram of the air conditioning system according to the first embodiment of the present invention, which illustrates the compressing operation state of the second compressor;

FIG. 6 is a flowchart illustrating a method of controlling the air conditioning system according to the first embodiment of the present invention;

FIG. 7 is a block diagram of an air conditioning system according to a second embodiment of the present invention; and

FIG. 8 is a sectional view illustrating the second compressor and the vane controller of the air conditioning system according to the second embodiment of the present invention.

### DETAILED DESCRIPTION OF THE EMBODIMENTS

Hereinafter, exemplary embodiments of the present invention will be described in detail with reference to the accompanying drawings.

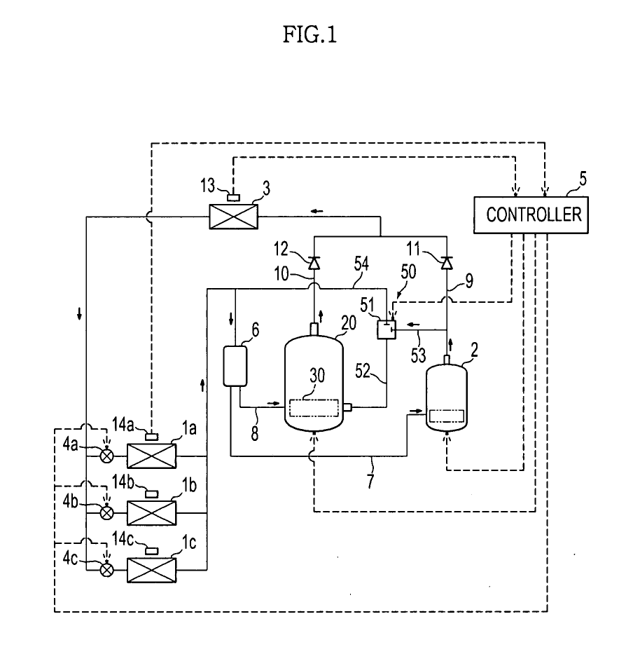

FIGS. 1 to 5 illustrate an air conditioning system according to a first embodiment of the present invention. As illustrated in FIG. 1, the air conditioning system according to the first embodiment includes a plurality of indoor heat exchangers 1a, 1b, and 1c connected in parallel to a refrigerant circulating circuit and a first compressor 2 and a second compressor 20 that compress the refrigerant that passes through the indoor heat exchangers 1a, 1b, and 1c. Also, the air conditioning system includes an outdoor heat exchanger 3 whose inlet is connected to the discharging sides of the first and second compressors 2 and 20 and whose outlet is connected to the plurality of indoor heat exchangers 1a, 1b, and 1c, a plurality of electronic expansion valves 4a, 4b, and 4c provided on the receiving sides of the indoor heat exchangers 1a, 1b, and 1c, and a controller 5 that controls the entire operation of the air conditioning system. The plurality of indoor heat exchangers 1a, 1b, and 1c and the electronic expansion valves 4a, 4b, and 4c are in the form of separate indoor units to be provided in separate indoor spaces and to thus be selectively operated as occasion demands.

The first compressor 2 and the second compressor 20 are connected in parallel to the refrigerant circulating circuit. The first compressor 2 is a common rotary compressor having fixed compression capacity and the second compressor 20 is a variable capacity rotary compressor that can vary the compression capacity of the refrigerant in accordance with a change in air conditioning load. A first suctioning pipe 7 extended from an accumulator 6 is connected to the suctioning opening of the first compressor 2 and a second suctioning pipe 8 extended from the accumulator 6 is connected to the suctioning opening of the second compressor 20. A first discharging pipe 9 and a second discharging pipe 10 extended from the discharging openings of the first and second compressors 2 and 20 are connected to each other to be united and are connected to the inlet of the outdoor heat exchanger 3. Also, check valves 11 and 12 that prevent a back flow are provided in the first discharging pipe 9 and the second discharging pipe 10.

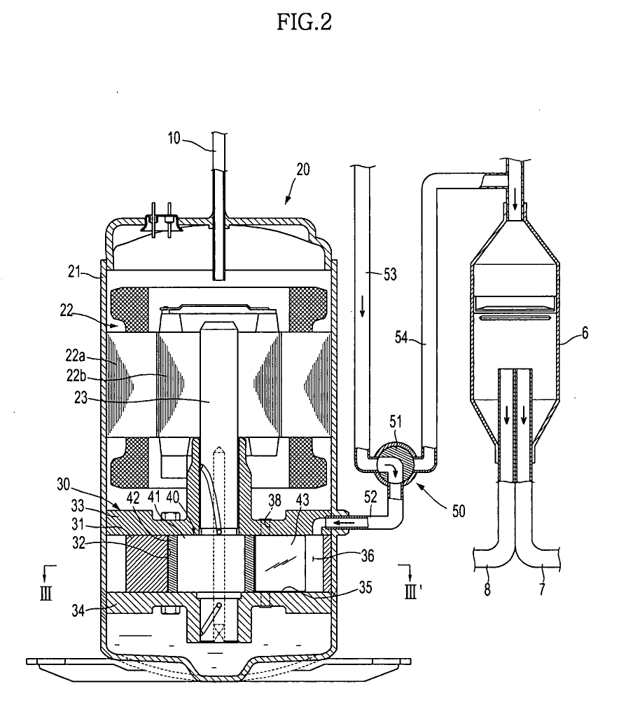

The second compressor 20 that can vary the compression capacity, as illustrated in FIG. 2, includes an electrically driven element 22 provided in the upper part of the inside of a closed vessel 21 and a compressing element 30 provided in the lower part of the inside of the closed vessel 21 to be connected to the electrically driven element 22 through a rotary shaft 23.

The electrically driven element 22 includes a cylindrical stator 22a fixed to the internal surface of the closed vessel 21 and a rotor 22b rotatably provided inside the stator 22a and whose center is coupled with the rotary shaft 23. The electrically driven element 22 drives the compressing element 30 connected to the rotary shaft 23 by the rotor 22b rotating when a power source is applied.

The compressing element 30 includes a housing 31 in which a compressing chamber 32 is formed and a compressing unit 40 provided in the compressing chamber 32 and operated by the rotary shaft 23. A first flange 33 and a second flange 34 that closes the upper and lower openings of the compressing chamber 32 and that supports the rotary shaft 23 are provided in the upper and lower parts of the housing 31. The rotary shaft 23 passes through the center of the compressing chamber 32 and is connected to the compressing unit 40 in the compressing chamber 32.

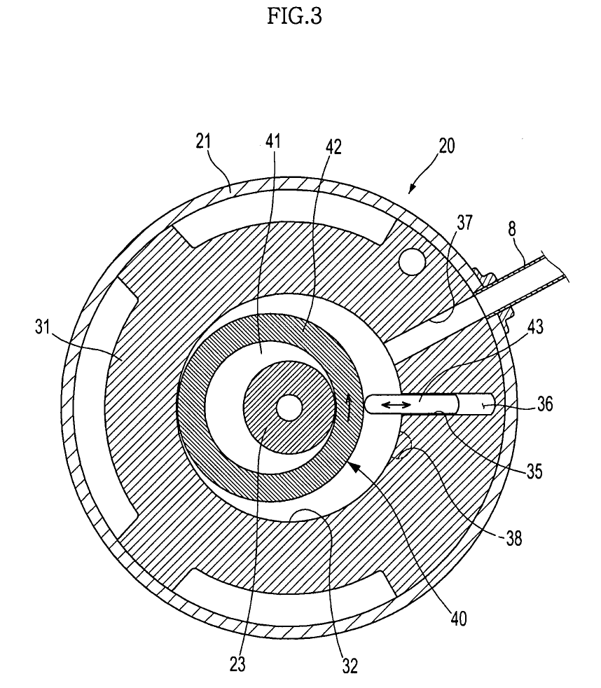

The compressing unit 40 includes an eccentric part 41 provided in the rotary shaft 32 of the compressing chamber 32, a roller 42 rotatably coupled with the external surface of the eccentric part 41 to rotate while contacting the internal surface of the compressing chamber 32, and a vane 43 that defines the compressing chamber 32 while proceeding and receding in the radial direction of the compressing chamber 32 in accordance with the rotation of the roller 42. The vane 43, as illustrated in FIG. 3, is accommodated in a vane guide groove 35 longitudinally formed in the radial direction of the compressing chamber 32 so that the proceeding and receding of the vane 43 are guided.

The rear part of the vane guide groove 35 in which the rear end of the vane 43 is accommodated is formed of a closed space 36. As illustrated in FIGS. 1 and 2, a vane controller 50 that applies suctioning pressure to the rear part of the vane guide groove 35 of the second compressor 20 to lock the vane 43 while the vane 43 recedes or that applies discharge pressure to the rear part of the vane guide groove 35 so that the vane 43 proceeds and recedes is provided outside the second compressor 20.

The vane controller 50 includes a control valve 51 that switches a fluid path so that the suctioning pressure and the discharge pressure can be selectively applied to the rear part of the vane guide groove 35, a connecting pipe 52 that connects the vane guide groove 35 and the control valve 51 to each other, a high pressure pipe 53 that connects the control valve 51 and the discharging side of the first compressor 2 to each other, and a low pressure pipe 54 that connects the control valve 51 and the suctioning sides of the first and second compressors 2 and 20. That is, according to the present invention, the discharge pressure of the first compressor 2 is used for controlling the operation of the vane 43 of the second compressor 20. The vane controller 50 locks or releases the vane 43 by the fluid path switching operation of the control valve 51 so that the second compressor 20 performs a compressing operation or and idling operation.

As illustrated in FIGS. 2 and 3, a suctioning opening 37 to which the second suctioning pipe 8 is connected so that a refrigerant is received to the compressing chamber 32 and a discharging opening 38 through which the gas compressed in the compressing chamber 32 is discharged to the inside of the closed vessel 21 are formed in the housing 31.

The controller 5, as illustrated in FIG. 1, receives temperature information transmitted from an outdoor temperature detector 13 on the side of the outdoor heat exchanger 3 and the indoor temperature detectors 14a, 14b, and 14c on the sides of the indoor heat exchangers 1a, 1b, and 1c, information on whether the electronic expansion valves 4a, 4b, and 4c provided on the sides of the indoor heat exchangers 1a, 1b, and 1c are opened or closed (information on whether indoor units operate when the indoor heat exchangers are in the forms of the separate indoor units), and input information of a user (desired temperatures of the indoor units). The controller 5 calculates the air conditioning load to calculate desired compression capacity based on such information items. Also, the controller 5 controls the driving of the first and second compressors 2 and 20 and the electronic expansion valves 4a, 4b, and 4c on the sides of the indoor heat exchangers 1a, 1b, and 1c and, although not shown in the drawing, controls the operations of outdoor fans on the sides of the outdoor heat exchanger 3 and indoor fans provided on the sides of the indoor heat exchangers 1a, 1b, and 1c.

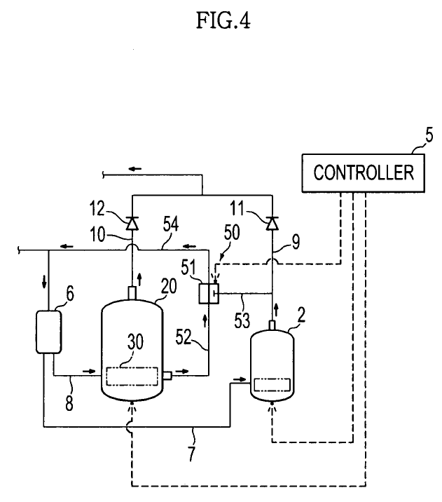

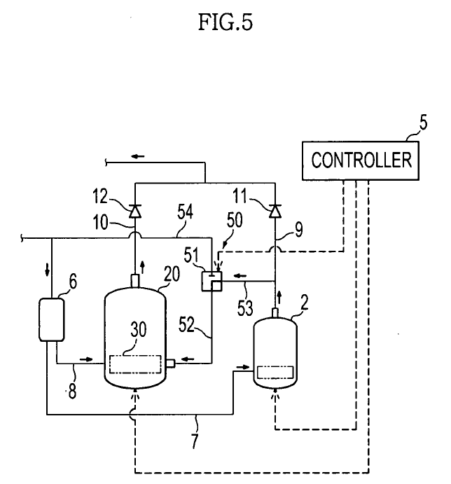

The controller 5 controls the fluid path switching operation of the control valve 51 in order to control the compressing and idling operations of the second compressor 20. Therefore, the control valve 51 operates so that the low pressure pipe 54 and the connecting pipe 52 of the vane controller 50 are connected to each other to apply the suctioning pressure to the closed space 36 in the rear part of the vane guide groove 35 as illustrated in FIG. 4 or so that the high pressure pipe 53 and the connecting pipe 52 of the vane controller 50 are connected to each other to apply the discharge pressure to the closed space 36 in the rear part of the vane guide groove 35 as illustrated in FIG. 5. Since the vane 43 recedes to be locked when the suctioning pressure is applied to the rear part of the vane guide groove 35, the compressing operation is not performed by the second compressor 20. Since the vane 43 proceeds when the discharge pressure is applied to the rear part of the vane guide groove 35, the compressing operation is performed by the second compressor 20.

The controller 5 controls the fluid path switching operation of the control valve 51 by a pulse width modulation (PWM) method so that the compression capacity of the second compressor 20 can vary with the air conditioning load. That is, a loading time when the discharge pressure is applied to the vane guide groove 35 in accordance with the air conditioning load so that vane 43 proceeds and an unloading time when the suctioning pressure is applied to the vane guide groove 35 so that the vane 43 is locked are changed to vary the compression capacity of the second compressor 20.

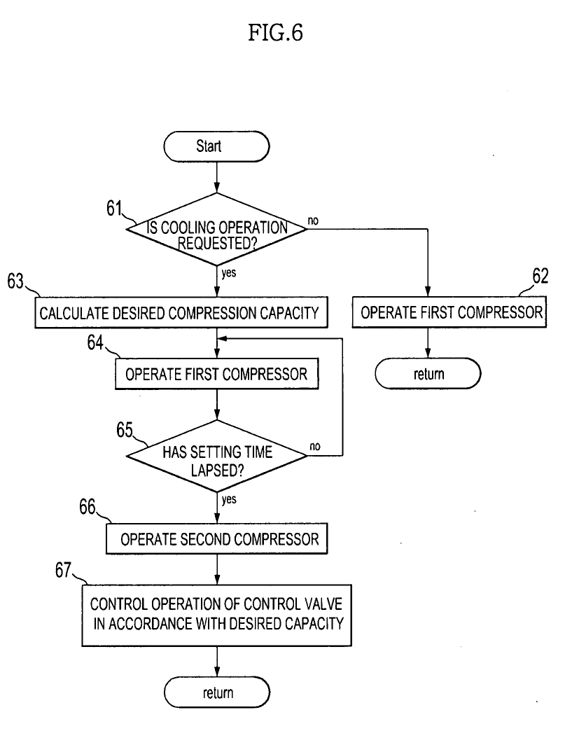

The operation of such an air conditioning system and a method of controlling the same will be described with reference to FIG. 6.

The controller 5 determines whether a cooling operation is requested (61) to stop an operation when it is determined that the cooling operation is not requested (62). When it is determined that the cooling operation is requested, the air conditioning load of the air conditioning system is calculated based on the temperature information received from the indoor temperature detectors 14a, 14b, and 14c and the outdoor temperature detector 13, the information on whether the electronic expansion valves 4a, 4b, and 4c on the sides of the indoor heat exchangers 1a, 1b, and 1c are opened or closed, and the operation information input by the user to calculate the desired compression capacity (63). The desired compression capacity can vary when the operation conditions of the air conditioning system change so that the air conditioning load changes.

After the desired compression capacity is calculated, the first compressor 2 and the second compressor 20 are sequentially driven to be suitable for the desired compression capacity (64 and 66). At this time, after the first compressor 2 is first operated, it is determined whether a setting time has lapsed after the first compressor 2 is driven (65). When it is determined that the setting time has lapsed, the second compressor 20 is operated. After the first compressor 2 is first driven so that enough discharge pressure is formed on the side of the first discharging pipe 9, the discharge pressure is applied to the vane guide groove 35 of the second compressor 20 so that the loading operation of the second compressor 20 is smoothly performed. That is, the discharge pressure is applied to the vane guide groove 35 at the same time when the second compressor 20 is driven so that the vane 43 rapidly and smoothly proceeds and recedes when the compressing operation is performed by the second compressor 20 and that the vane 43 does not chatter.

After the first compressor 2 and the second compressor 20 are driven by such a method, the controller 5 controls the control valve 51 by the PWM method so that the desired compression capacity of the air conditioning system is realized to control the compression capacity of the second compressor 20 (67).

For example, in a case where the compression capacity of the first compressor 2 occupies 30% of the entire compression capacity of the air conditioning system and where the maximum compression capacity of the second compressor 20 occupies 70% of the entire compression capacity, when the desired compression capacity of the air conditioning system occupies 30%, it is possible to realize the desired compression capacity only by the first compressor 2 performing the compressing operation. Therefore, at this time, the suctioning pressure is continuously applied to the rear space of the vane 43 of the second compressor 20 so that the vane 43 is locked. When a state in which the discharge pressure is applied to the rear space of the vane 43 so that the vane 43 proceeds and recedes is referred to as a loading state and a state in which the suctioning pressure is applied to the rear space of the vane 43 so that the vane 43 is locked is referred to as an unloading state, the controller 5 controls all of the fluid path switching periods of the control valve 51 to be in the unloading state. When the fluid path switching period of the control valve 51 is 20 seconds, all of the 20 seconds are maintained to be in the unloading state so that the compressing operation is not performed by the second compressor 20.

When the desired compression capacity of the air conditioning system occupies 65%, 30% of the desired compression capacity is realized by the first compressor 2 and 35% of the desired compression capacity is realized by the second compressor 20. Therefore, the controller 5 controls 50% of the fluid path switching period of the control valve 51 to be in the loading state so that the compression capacity of 35% that is the half of the compression ability (70%) of the second compressor 20 is realized. When the fluid path switching period of the control valve 51 is 20 seconds, it is controlled that 10 seconds are in the loading state and that 10 seconds are in the unloading state.

When the desired compression capacity of the air conditioning system occupies 72%, 30% of the desired compression capacity is realized by the first compressor 2 and 42% of the desired compression capacity is realized by the second compressor 20. Therefore, the controller 5 controls 60% of the fluid path switching period of the control valve 51 to be in the loading state and 40% of the fluid path switching period of the control valve 51 to be in the unloading state so that the compression capacity of 42% that is 60% of the compression ability (70%) of the second compressor 20 is realized. When the fluid path switching period of the control valve 51 is 20 seconds, it is controlled that 12 seconds are in the loading state and that 8 seconds are in the unloading state.

When the desired compression capacity of the air conditioning system is 100%, 30% of the desired compression capacity is realized by the first compressor 2 and 70% of the desired compression capacity is realized by the second compressor 20. Therefore, the controller 5 controls 100% of the fluid path switching period of the control valve 51 to be in the loading state so that 100% of the compression ability 70% is realized. That is, all of 20 seconds of the fluid path switching period of the control valve 51 are maintained to be in the loading state.

As described above, since the air conditioning system according to the present invention controls the control valve 51 by the PWM method to control the compression capacity of the second compressor 20, it is possible to easily realize the desired compression capacity in accordance with a change in the air conditioning load and to variously change the compression capacity from 30% to 100%. That is, it is possible to control the compression capacity in multiple steps so as to be suitable for the desired compression capacity. Therefore, it is possible to improve the energy efficiency of the air conditioning system.

Also, the air conditioning system according to the present invention can vary the compression capacity in multiple steps while adopting a common constant speed motor as the driving source of the first compressor and the second compressor. Therefore, it is possible to reduce the manufacturing costs of the air conditioning system compared with the air conditioning system that adopts a conventional inverter.

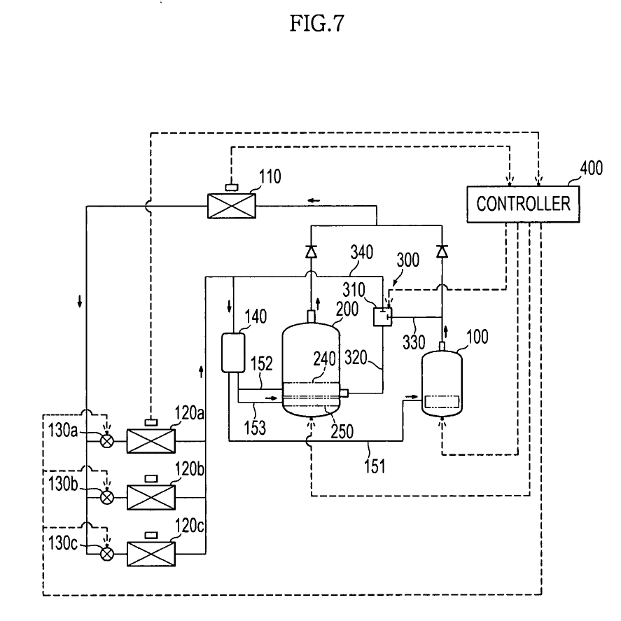

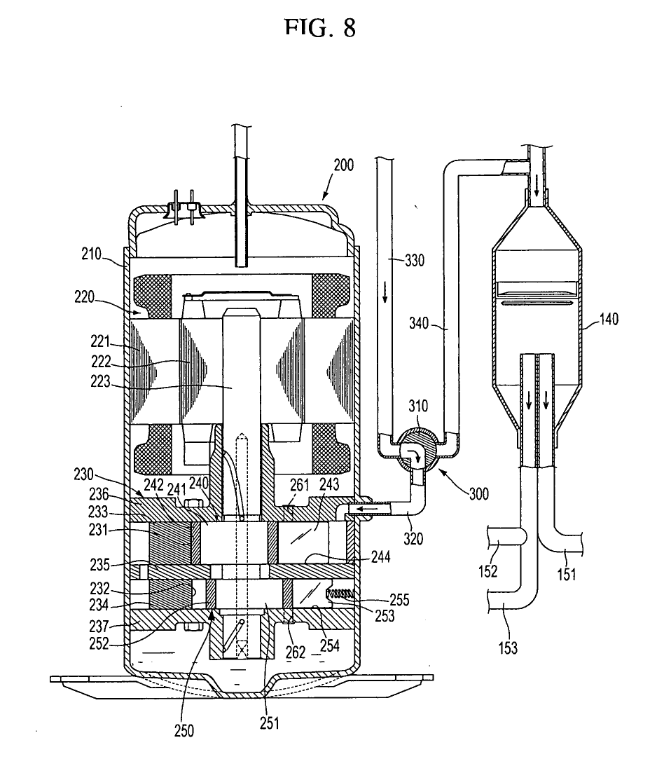

FIGS. 7 and 8 illustrate an air conditioning system according to a second embodiment of the present invention. The air conditioning system according to the second embodiment, as illustrated in FIG. 7, like the air conditioning system according to the first embodiment, includes a first compressor 100 and a second compressor 200 provided in parallel, an outdoor heat exchanger 110, a plurality of indoor heat exchangers 120a, 120b, and 120c, a plurality of electronic expansion valves 130a, 130b, and 130c, a vane controller 300 that controls the compression capacity variation of the second compressor 200, and a controller 400 that controls the entire operation of the air conditioning system. The second embodiment is different from the first embodiment in that the second compressor 200 includes a plurality of compressing chambers as illustrated in FIG. 8.

The second compressor 200, as illustrated in FIG. 8, includes an electrically driven element 220 provided in the upper part of the inside of a closed vessel 210 and having a stator 221 and a rotor 222 and a compressing element 230 provided in the lower part of the inside of the closed vessel 210 and connected to the rotor 222 of the electrically driven element 220 by a rotary shaft 223.

The compressing element 230 includes a housing having a first compressing chamber 231 formed in the upper part thereof and a second compressing chamber 232 formed in the lower part thereof, which are separated from each other, and first and second compressing units 240 and 250 provided in the first and second compressing chambers 231 and 232 so as to be operated by the rotary shaft 223.

The housing includes a first body 233 formed in the upper part thereof in which the first compressing chamber 231 is formed, a second body 234 in which the second compressing chamber 232 is formed and that is provided under the first body 233, an intermediate plate 235 provided between the first and second bodies 233 and 234 in order to separate the first compressing chamber 231 from the second compressing chamber 232, and first and second flanges 236 and 237 mounted on the first body 233 and under the second body 234 so as to close the upper opening of the first compressing chamber 231 and the lower opening of the second compressing chamber 232 and to support the rotary shaft 223. The rotary shaft 223 passes through the centers of the first and second compressing chambers 231 and 232 to be connected to the compressing units 240 and 250 in the first and second compressing chambers 231 and 232.

The first and second compressing units 240 and 250 include first and second eccentric parts 241 and 251 provided in the rotary shaft 223 of the first and second compressing chambers 231 and 232 and first and second rollers 242 and 252 rotatably coupled with the external surfaces of the first and second eccentric parts 241 and 251 so as to rotate while contacting the internal surfaces of the first and second compressing chambers 231 and 232. The eccentric directions of the first and second eccentric parts 241 and 251 are opposite to each other so as to be balanced.

The first and second compressing units 240 and 250 include a first vane 243 and a second vane 253 that define the compressing chambers 231 and 232 while proceeding and receding in the radial directions of the compressing chambers 231 and 232 in accordance with the rotation of the first and second rollers 242 and 252. The first vane 243 and the second vane 253 are accommodated in first and second vane guide grooves 244 and 254 longitudinally formed in the radial directions of the compressing chambers 231 and 232 so that the proceeding and receding of the first vane 243 and the second vane 253 are guided. A vane spring 255 that biases the second vane 253 toward the second roller 252 is provided in the second vane guide groove 254, so the second vane 253 can define the second compressing chamber 232.

The vane controller 300 that selectively applies the suctioning pressure and the discharge pressure to the first vane guide groove 244 to lock or release the first vane 243 is provided in the rear part of the first vane guide groove 244. The vane controller 300 includes a control valve 310 that switches a fluid path so as to selectively apply the suctioning pressure and the discharge pressure to the rear part of the first vane guide groove 244, a connecting pipe 320 that connects the first vane guide groove 244 and the control valve 310 to each other, a high pressure pipe 330 that connects the control valve 310 and the discharging side of the first compressor 100 to each other, and a low pressure pipe 340 that connects the control valve 310 and the suctioning sides of the first and second compressors 100 and 200 to each other. The operation principle of the vane controller 300 is the same as that of the first embodiment.

As illustrated in FIG. 7, a first suctioning pipe 151 extended from an accumulator 140 is connected to the first compressor 100. As illustrated in FIGS. 7 and 8, a second suctioning pipe 152 and a third suctioning pipe 153 extended from the accumulator 140 are connected to the second compressor 200 so that a refrigerant gas can be received to the insides of the first compressing chamber 231 and the second compressing chamber 232. First and second discharging openings 261 and 262 through which the gas compressed in the compressing chambers 231 and 232 is discharged to the inside of the closed vessel 210 are formed in the second compressor 200.

According to the second embodiment, the control valve 310 of the vane controller 300 is controlled by the controller 400 by the PWM method so that the second compressor 200 can vary the compression capacity by the first compressing chamber 231. A continuous compressing operation is performed by the second compressing chamber 232.

According to the second embodiment, the first compressor 100 stops driving and compression is performed only by the second compressing chamber 232 in the second compressor 200 so that it is possible to minimize the compression capacity. Also, the compressing operation is performed only by the second compressing chamber 232 of the second compressor 200 in a state where the compressing operation is performed by the first compressor 100 so that it is possible to increase the compression capacity. Also, the control valve 310 is controlled by the PWM method in order to vary the compression capacity of the first compressing chamber 231 of the second compressor 200 in a state where the compression is performed by the first compressor 100 and the second compressing chamber 232 of the second compressor 200 so that it is possible to control the compression capacity in multiple steps so as to be suitable for the desired compression capacity.

As described above, since the air conditioning system according to the present invention controls the control valve that varies the capacity of the second compressor by the PWM method to control the compression capacity, it is possible to vary the compression capacity in multiple steps in accordance with the change in the air conditioning load.

Also, according to the present invention, since the vane operation of the second compressor is controlled using the discharge pressure of the first compressor, it is possible to apply enough discharge pressure to the vane guide groove of the second compressor so that it is possible to smoothly control the operation of the vane of the second compressor and to rapidly vary the compression capacity. In particular, since it is possible to prevent the vane from chattering when the operation of the vane of the second compressor is controlled, it is possible to reduce the operation noise of the second compressor in accordance with the variation of the compression capacity.

Also, according to the present invention, since the control valve of the vane controller is controlled by the PWM method to vary the compression capacity of the second compressor, it is possible to realize the air conditioning system capable of varying the compression capacity while using the common constant speed motor of a low price as the driving source of the first compressor and the second compressor. Therefore, it is possible to reduce the manufacturing costs of the air conditioning system compared with the air conditioning system that adopts the conventional inverter.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An air conditioning system comprising:
a first compressor; and
a second compressor provided in parallel with the first compressor to vary compression capacity,
wherein the second compressor comprises:
a housing having a compressing chamber;
a vane that moves forward or backward in a radial direction of the compressing chamber;
a vane guide groove formed in the housing to guide the vane moving in a forward direction or a backward direction; and
a vane controller that controls the movement of the vane in order to vary capacity,
wherein the vane controller comprises a control valve that switches a fluid path so as to selectively apply suctioning pressure of the first or second compressor and discharge pressure of the first compressor to the vane guide groove.

2. The air conditioning system as claimed in claim 1, wherein the vane controller comprises:
a connecting pipe that connects the vane guide groove to the control valve;
a high pressure pipe that connects the control valve to a discharging side of the first compressor; and
a low pressure pipe that connects the control valve to a suctioning side of the first or second compressor.

3. The air conditioning system as claimed in claim 1, further comprising a controller that controls an operation of the control valve by a pulse width modulation (PWM) method in order to vary compression capacity of the second compressor in accordance with air conditioning load.

4. The air conditioning system as claimed in claim 1, further comprising:
an outdoor heat exchanger connected to discharging sides of the first and second compressors;
an indoor heat exchanger having an inlet connected to the outdoor heat exchanger and an outlet connected to suctioning sides of the first and second compressors; and
an electronic expansion valve provided on a receiving side of the indoor heat exchanger.

5. The air conditioning system as claimed in claim 4, wherein the indoor heat exchanger comprises a plurality of indoor heat exchangers provided in parallel to each other, and the electronic expansion valve comprises a plurality of electronic expansion valves provided on the receiving side of each indoor heat exchanger.

6. An air conditioning system comprising:
a first compressor; and
a second compressor provided in parallel with the first compressor to vary compression capacity,
wherein the second compressor comprises:
a housing having first and second compressing chambers which are separated from each other;
first and second vanes that move forward or backward in a radial direction of the compressing chambers;
first and second vane guide grooves formed in the housing to guide the first and second vanes moving in a forward direction or a backward direction; and
a vane controller that controls an operation of the first vane in order to vary capacity, and
wherein the vane controller comprises a control valve that switches a fluid path so as to selectively apply suctioning pressure of the first or second compressor and discharge pressure of the first compressor to the first vane guide groove.

7. The air conditioning system as claimed in claim 6, wherein the vane controller comprises:
a connecting pipe that connects the first vane guide groove to the control valve;
a high pressure pipe that connects the control valve to a discharging side of the first compressor; and
a low pressure pipe that connects the control valve to a suctioning side of the first or second compressor.

8. The air conditioning system as claimed in claim 6, further comprising a controller that controls an operation of the control valve by a PWM method in order to vary compression capacity of the second compressor in accordance with air conditioning load.

9. The air conditioning system as claimed in claim 6, further comprising:
an outdoor heat exchanger connected to discharging sides of the first and second compressors;
an indoor heat exchanger having an inlet connected to the outdoor heat exchanger and an outlet connected to suctioning sides of the first and second compressors; and
an electronic expansion valve provided on a receiving side of the indoor heat exchanger.

10. The air conditioning system as claimed in claim 9, wherein the indoor heat exchanger comprises a plurality of indoor heat exchangers provided in parallel to each other, and the electronic expansion valve comprises a plurality of electronic expansion valves provided on the receiving side of each indoor heat exchanger.

11. A method of controlling an air conditioning system including a first compressor and a second compressor provided in parallel with the first compressor to vary compression capacity by controlling forward and backward movements of a vane and a control valve that switches a fluid path so as to selectively apply suctioning pressure of the second compressor and discharge pressure of the first compressor to a rear space of the vane in order to control the forward and backward movements of the vane, the method comprising:
driving the second compressor after a predetermined time has lapsed from a driving point of the first compressor.

12. The method as claimed in claim 11, wherein desired compression capacity in accordance with air conditioning load is calculated before driving the first compressor, and a fluid path switching operation of the control valve is controlled by a PWM method in order to realize compression capacity suitable for the desired compression capacity after driving the second compressor.

13. The method as claimed in claim 11, wherein a compressing operation of the second compressor is performed after a discharge pressure of the first compressor is applied to a rear space of the vane.

14. A method of controlling an air conditioning system including a first compressor and a second compressor provided in parallel with the first compressor to vary compression capacity by controlling forward and backward movements of a vane and a control valve that switches a fluid path so as to selectively apply suctioning pressure of the second compressor and discharge pressure of the first compressor to a rear space of the vane in order to control the forward and backward movements of the vane, the method comprising:
calculating desired compression capacity in accordance with air conditioning load; and controlling a fluid path switching operation of the control valve by a PWM method in order to realize compression capacity suitable for the desired compression capacity after driving the first and second compressors.
